(19) United States
(12) Patent Application Publication
(10) Pub. No.: US 2006/0143378 A1
(43) Pub. Date: Jun. 29, 2006

(54) Information processing apparatus and control method for this information processing apparatus

(75) Inventor: Tadaaki Kinoshita, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/298,524

(22) Filed: Dec. 12, 2005

(30) Foreign Application Priority Data
Dec. 28, 2004 (JP) 2004-380501

(51) Int. Cl. G06F 13/00

(52) U.S. Cl. 711/113; 360/69

(57) ABSTRACT

An information processing apparatus includes a obtaining circuit to obtain control information necessary for an operation requested through a communication with the external device upon the occurrence of one of requests to write the information to the first recording medium and to read the information from the first recording medium by use of the second recording medium, and a controller which performs one of writing of the information to the first and second recording media and reading of the information from the first and second recording media, based on the control information.

### CROSS-REFERENCE TO RELATED APPLICATIONS

This application is based upon and claims the benefit of priority from prior Japanese Patent Application No. 2004-380501, filed Dec. 28, 2004, the entire contents of which are incorporated herein by reference.

### BACKGROUND OF THE INVENTION

1. Field of the Invention

This invention relates to an information processing apparatus and a control method for this information processing apparatus which has, for example, a cache memory and which can record information from an external host computer on a storage medium such as a hard disk drive (HDD) by use of the cache memory or read information from the storage medium to send the information to the host computer.

2. Description of the Related Art

As is well known, in a computer system, there is an information processing apparatus which can record information from a host computer on a storage medium such as an HDD by use of a cache memory or read information from the storage medium to send the information to the host computer.

In this case, a controller which controls the cache memory can immediately write request data to the storage medium or temporarily store the write request data in the cache memory and then write (flash) it to the storage medium, depending on whether to use a write-back cache processing method.

Especially, the information processing apparatus described above is useful in that frequently used data is stored in the cache memory, while less frequently used data is stored on the storage medium, thereby enabling acceleration of processing.

Furthermore, a system has been proposed wherein in the information processing apparatus described above, when there are accesses from a plurality of host computers, the cache memory is divided into a plurality of segments, and the segments are associated with the host computers such that the cache hit ratio of access from a certain host computer is not influenced by the pattern of access from another host computer (see, for example, Document 1: Jpn. Pat. Appln. KOKAI Publication No. 2004-139349).

Meanwhile, in the system described above, the cache memory is controlled on the information processing apparatus side, and it is impossible to recognize, on the host computer side, a miss-hit in reading information, and occurrence of delay due to cache overflow in writing information.

### BRIEF SUMMARY OF THE INVENTION

It is therefore an object of this invention to provide an information processing apparatus and a control method for this information processing apparatus which can eliminate a miss-hit in reading information and occurrence of delay due to cache overflow in writing information during access to a storage medium which involves operations using a cache memory in order to enable efficient access to the storage medium.

According to an aspect of the present invention, there is provided an information processing apparatus which performs at least one of an operation of directly writing and reading arbitrary information to and from a first recording medium, an operation of temporarily retaining information to be written to the first recording medium in a second recording medium and then writing the information to the first recording medium, and an operation of temporarily retaining information read from the first recording medium in the second recording medium and then reading the information from the second recording medium, in response to a request from an external device, the information processing apparatus comprising: a obtaining circuit to obtain control information necessary for an operation requested through a communication with the external device upon the occurrence of one of requests to write the information to the first recording medium and read the information from the first recording medium by use of the second recording medium; and a controller which performs one of writing of the information to the first and second recording media and reading of the information from the first and second recording media, based on the control information.

According to another aspect of the present invention, there is provided a control method for an information processing apparatus which performs at least one of an operation of directly writing and reading arbitrary information in and from a first recording medium, an operation of temporarily retaining information to be written to the first recording medium in a second recording medium and then writing the information to the first recording medium, and an operation of temporarily retaining information read from the first recording medium in the second recording medium and then reading the information from the second recording medium, in response to a request from an external device, the method comprising: obtaining control information necessary for an operation requested through a communication with the external device upon the occurrence of one of requests to write the information to the first recording medium and read the information from the first recording medium by use of the second recording medium; and performing one of writing of the information to the first and the second recording media and reading of the information from the first and the second recording media, based on the control information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of an information processing apparatus in a first embodiment according to this invention;

FIG. 2 is a block diagram showing a specific configuration of a device controller shown in FIG. 1;

FIG. 3 is a diagram showing structures of packets transmitted to or received from a host apparatus in the first embodiment;

FIG. 4 is a diagram showing one example of stored contents in a cache memory management table shown in FIG. 2;

FIG. 5 is a diagram showing one example of stored contents in a cache type-method matching table shown in FIG. 2;

FIG. 6 is a diagram showing one example of stored contents in a bit-status matching table shown in FIG. 2;

FIG. 7 is a flowchart showing a control processing procedure of a data transfer control section when data is written to a storage medium and the cache memory in the first embodiment;

FIG. 8 is a flowchart showing the control processing procedure of the data transfer control section when data in the cache memory is transferred to the storage medium in the first embodiment;

FIG. 9 is a flowchart showing the control processing procedure of the data transfer control section when data is read from the storage medium in the first embodiment;

FIG. 10 is a flowchart showing the control processing procedure of the data transfer control section when registration is conducted from the host apparatus to the cache memory management table in the first embodiment;

FIG. 11 is a flowchart showing a control processing procedure of a storage device when a request to read status data of the storage medium and the cache memory has arrived from the host apparatus in the first embodiment; and

FIG. 12 is a block diagram showing a configuration of an information processing apparatus in a second embodiment according to this invention.

### DETAILED DESCRIPTION OF THE INVENTION

Embodiments of this invention will hereinafter be described in detail in reference to the drawings.

### First Embodiment

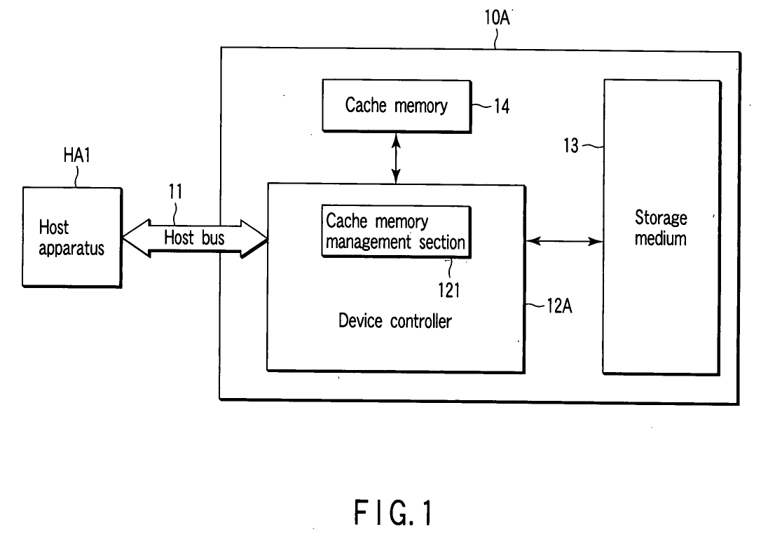

FIG. 1 is a block diagram showing a configuration of an information processing apparatus in a first embodiment according to this invention.

A host apparatus HA1 as an external apparatus is connected to a storage device 10A by a host bus 11. Here, the storage device 10A functions as an information processing apparatus, and writes/reads data to/from a storage medium 13 such as a nonvolatile memory or a disk device based on a command packet as control information received from the host apparatus HA1 by a device controller 12A via the host bus 11, thereby making it possible to control writing/reading to/from a cache memory 14. The device controller 12A has a cache memory management section 121 which manages addresses of the storage medium 13 and the cache memory 14 and recording states of data.

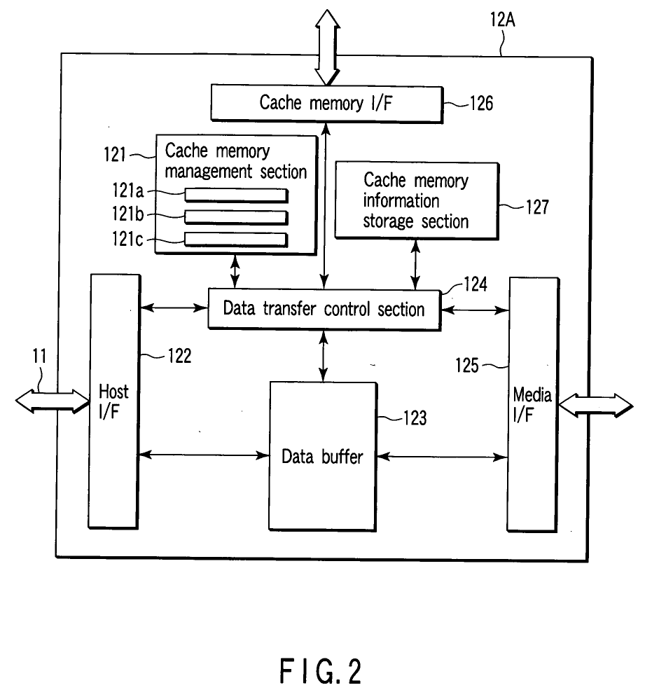

FIG. 2 is a block diagram showing a specific configuration of the device controller 12A.

The device controller 12A comprises, in addition to the cache memory management section 121, a host interface (I/F) 122, a data buffer 123, a data transfer control section 124, a media interface (I/F) 125, a cache memory interface (I/F) 126 and a cache memory information storage section 127.

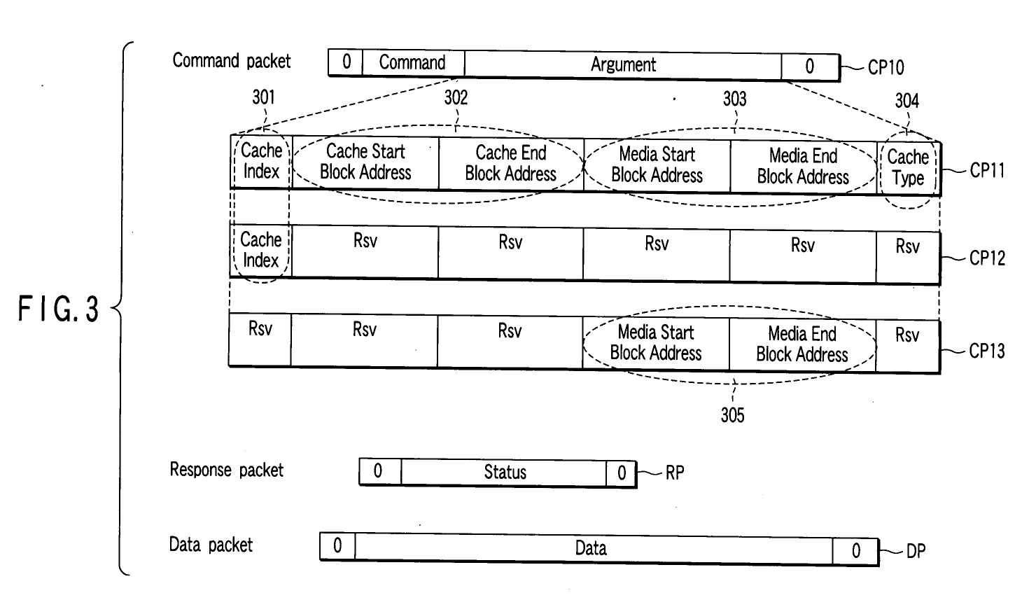

The host I/F 122 imports a command packet CP10 shown in FIG. 3 sent from the host apparatus HA1 via the host bus 11, transfers it to the data buffer 123, and, after termination of the transfer, informs the data transfer control section 124 of a region where the command packet CP10 exists in the data buffer 123.

The data transfer control section 124 imports the command packet CP10 from the data buffer 123 on the basis of the information from the host I/F 122, analyzes the command packet CP10, and specifies a write address or read address and a data transfer amount for the media I/F 125 and the cache memory I/F 126. Subsequently, the data transfer control section 124 transmits a response packet RP indicating states of the storage medium 13 and the cache memory 14 to the host apparatus HA1.

The media I/F 125 transfers data stored in the data buffer 123 to the storage medium 13 and writes thereto, or reads information from the storage medium 13 and transfers it to the data buffer 123, in accordance with the data transfer amount specified from the write address or read address specified by the data transfer control section 124. After having finished reading, the media I/F 125 informs the data transfer control section 124 that a corresponding region in the storage medium 13 is in an open state.

The cache memory I/F 126 transfers the data stored in the data buffer 123 to the cache memory 14 and writes thereto, or reads information from the cache memory 14 and transfers it to the data buffer 123, in accordance with the data transfer amount specified from the write address or read address specified by the data transfer control section 124.

The data buffer 123 stores the data transferred from the storage medium 13 and the data transferred from the cache memory 14 through the data transfer control section 124, and properly outputs the data to the host apparatus HA1 via the host I/F 122 and the host bus 11.

On the other hand, the cache memory management section 121 comprises a cache memory management table 121a (table 121a), a cache type-method matching table 121b (table 121b) and a bit-status matching table 121c (table 121c).

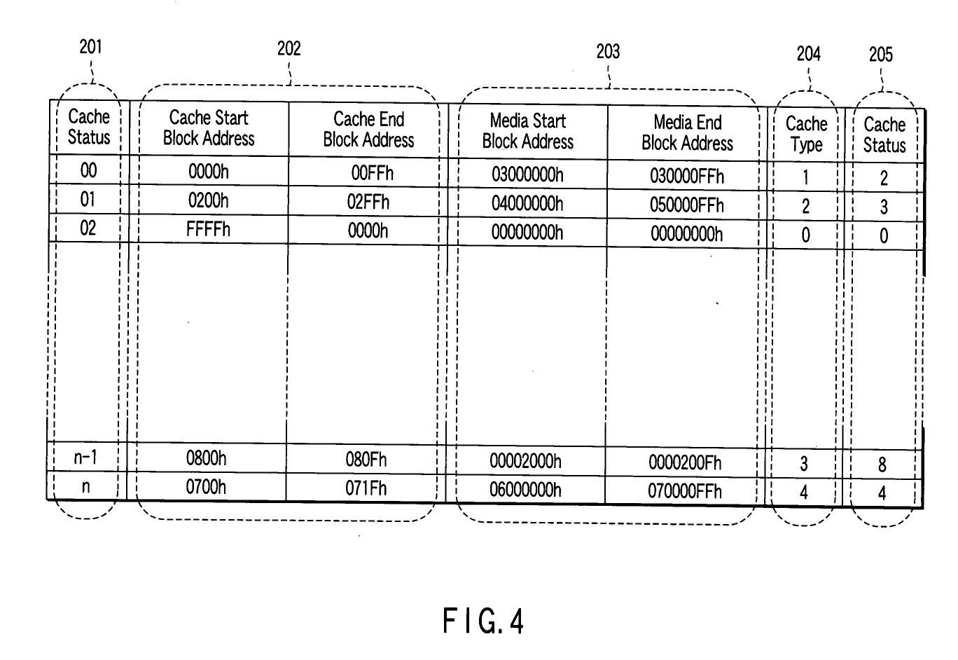

As shown in FIG. 4, the table 121a stores data indicating a relation among a cache index 201, a cache addressing field 202, a storage media data addressing field 203, a cache type field 204 and a cache status 205.

The cache addressing field 202 and the storage media data addressing field 203 are used to map a storage media data write or read address to an address of the cache memory 14.

The cache type field 204 is used to specify a type and the like of a cache replacement method represented by, for example, known LRU, round robin and random methods, and a type and the like of a write control method represented by, for example, known write-through and write-back methods.

The cache status 205 indicates cache states, for example, whether the cache is empty or full, whether writing or reading is performed on the storage medium 13.

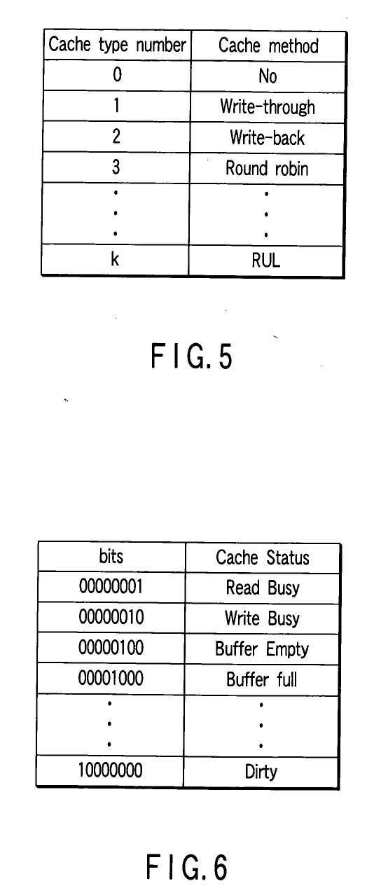

The table 121b stores data indicating a relation between cache type numbers and cache methods, as shown in FIG. 5.

The table 121c stores data indicating a relation between bits and cache status, as shown in FIG. 6.

Here, the data transfer control section 124 can perform data access to the table 121a with the command packet CP10 involving an argument and the response packet RP from the host I/F 122.

Furthermore, the cache memory information storage section 127 is connected to the data transfer control section 124. The cache memory information storage section 127 stores information on capacity of the cache memory 14 and information on a speed of accessing the cache memory 14. Then, in response to a request from the host apparatus HA1, the data transfer control section 124 reads the capacity information and the access speed information from the cache memory information storage section 127 and transmits them to the host apparatus HA1.

Next, an operation in the above configuration will be described.

Here, a command, a response or data is transmitted/received in a packet form between the storage device 10A and the host apparatus HA1 via the host bus 11. An arbitrary command number and an arbitrary value corresponding to the command number are set to a command identifier and an argument of the command packet CP10.

For a command to write to the table 121a, argument contents indicated by CP11 are set. For a command to check the cache status implemented on the table 121a, argument contents indicated by CP12 are set. For a command to write into or read from the storage device 10A, argument contents indicated by CP13 are set.

When the command packet CP10 is transmitted to the storage device 10A via the host bus 11, the storage device 10A transmits, to the host apparatus HA1, the response packet RP to the command packet CP10, and in a status field of the response packet RP, a value of the cache status is included for a command to check the cache status. When the read or write access command packet CP13 is transmitted to the storage device 10A via the host bus 11, a data packet DP is transmitted/received between the host apparatus HA1 and the storage device 10A depending on reading or writing.

The data transfer control section 124 informed via the host I/F 122 of receipt of the command to write to the table 121a replaces the cache addressing field 202, the storage media data addressing field 203 and the cache type field 204 on the table 121a referred to by a cache index 301 of the command packet CP11 with a cache addressing field 302, a storage media data addressing field 303 and a cache type field 304 specified by the command argument.

The data transfer control section 124 informed via the host I/F 122 of receipt of the command to check the cache status stores, in the status field of the response packet RP, the cache status value 205 in the table 121a referred to by cache index 301 of the command packet CP12, and informs the host apparatus HA1 thereof via the host I/F 122.

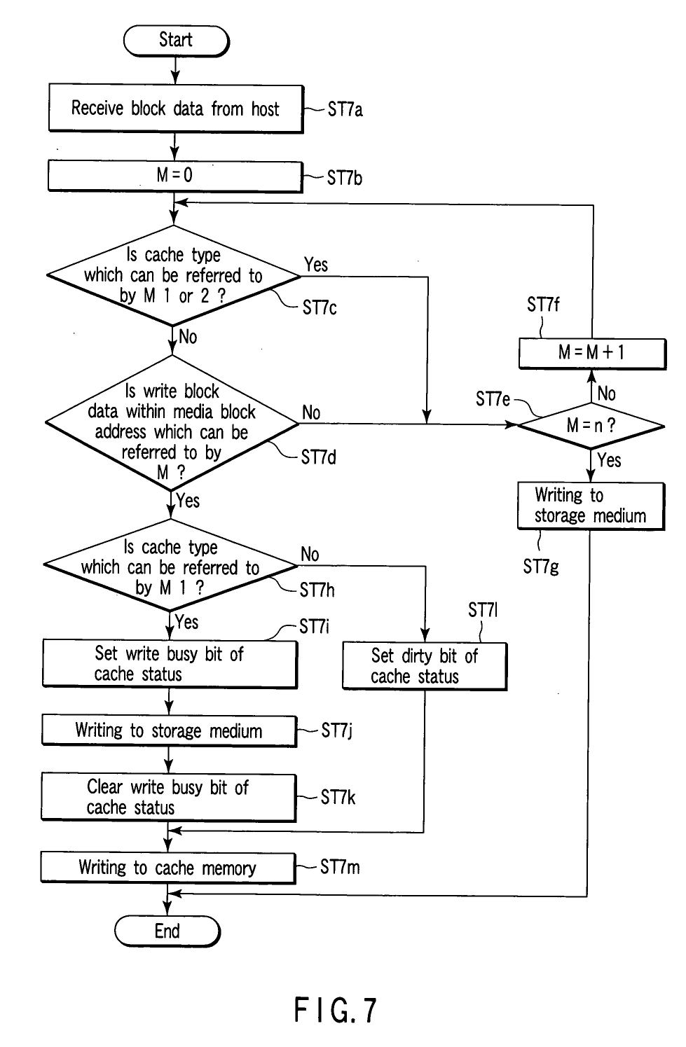

FIG. 7 is a flowchart showing a control processing procedure of the data transfer control section 124 when the command packet CP13 including the write command from the host apparatus HA1 and a block address 305 to the storage medium 13 is received in the storage device 10A.

Here, write data packets can be sequentially stored in the data buffer 123 in block units, and the storage media block address 203 is not duplicated among the indices.

First, the data transfer control section 124 which has received the write command CP11 via the host I/F 122 stores write data from the host apparatus HA1 to the data buffer 123 in one block unit, and starts data transfer control (step ST7a). Here, reference is made starting from an index value 0 (step ST7b).

The data transfer control section 124 judges whether a write cache operation is valid or invalid by referring to the cache type field 204 in the table 121a which can be referred to by an index value M (step ST7c), and judges whether a write block data address is in the storage medium block address space 305 if the write cache operation is valid (step ST7d).

If the write cache operation is invalid in step ST7c or if the write block data address is out of the storage medium block address space 305 in step ST7d, the data transfer control section 124 checks whether the index reference value M is equal to a maximum index value n on the table 121a (step ST7e). If they are not equal, the data transfer control section 124 increments M to refer to a next index value (step ST7f), and again shifts to the processing in step ST7c.

On the other hand, if they are equal in step ST7e, the data transfer control section 124 writes the block data onto the storage medium 13, and terminates the processing (step ST7g).

Furthermore, when the write block data address is in the storage medium block address space 305 in step ST7d (Yes), the data transfer control section 124 judges whether the processing is the write-through or write-back processing by referring to the cache type field 204 in the table 121a which can be referred to by the index value M (step ST7h). If it is the write-through processing, the data transfer control section 124 sets a write busy bit in the cache status (step ST7i), writes the write block data to the storage medium 13 (step ST7j), and clears the write busy bit in the cache status (step ST7k). On the other hand, if the processing is the write-back processing (No), the data transfer control section 124 sets a dirty bit in the cache status (step ST7l).

It is to be noted that regardless of whether the processing is judged to be the write-through or write block processing in step ST7h, the write block data is written to the cache memory 14 and then the processing is terminated (step ST7m).

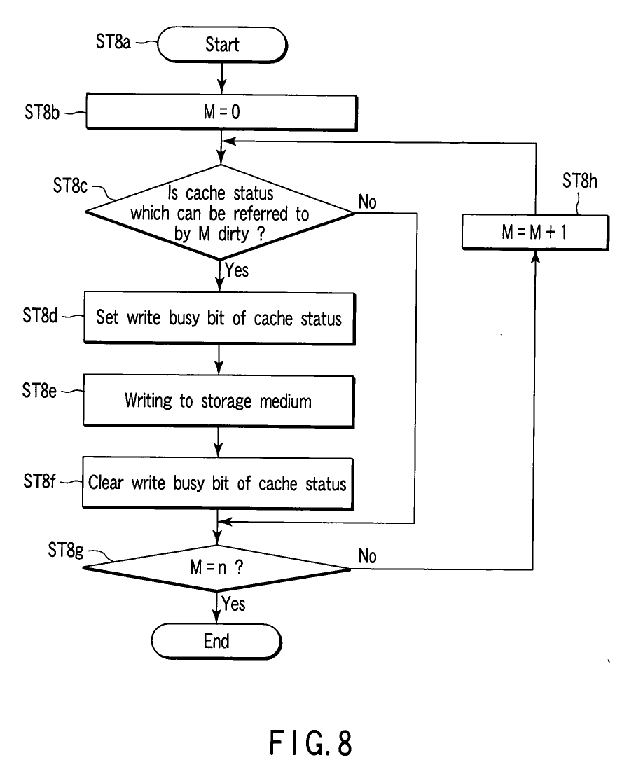

FIG. 8 is a flowchart showing the control processing procedure of the data transfer control section 124 when a command packet CP10 including a flash command from the host apparatus HA1 is received in the storage device 10A.

The data transfer control section 124 which has received the command packet CP10 via the host I/F 122 starts data transfer control (step ST8a). Here, reference is made starting from an index value 0 (step ST8b).

The data transfer control section 124 judges whether or not there exists any dirty bit by referring to the cache status 205 in the table 121a which can be referred to by the index value M (step ST8c).

Here, when the cache status is dirty (Yes), the data transfer control section 124 sets the write busy bit in the cache status (step ST8d), and transfers block data stored in a space of the cache block address 202 of the cache memory 14 to the storage medium 13 and writes the block data therein (step ST8e), and then clears the write busy bit in the cache status (step ST8f).

If there is not any dirty bit after termination of the processing of step ST8f or in step ST8c (No), the data transfer control section 124 checks whether the index reference value M is equal to the maximum index value n in the table 121a (step ST8g). If they are not equal, the data transfer control section 124 increments M to refer to a next index value (step ST8h), and again shifts to the processing in step ST8c. If they are equal, the processing is terminated.

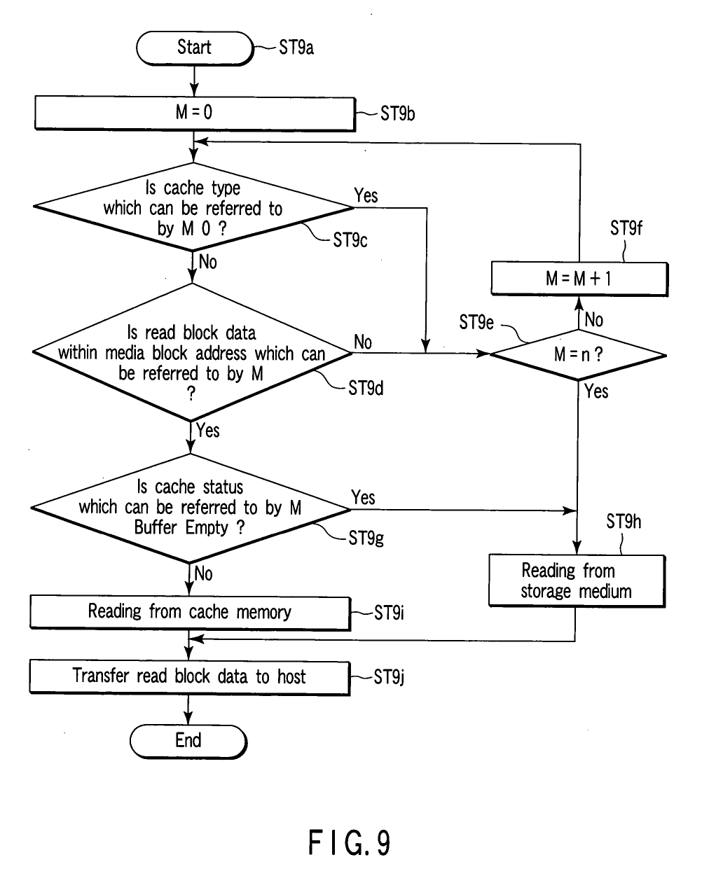

FIG. 9 is a flowchart showing the control processing procedure of the data transfer control section 124 when the command packet CP10 including a read command from the host apparatus HA1 and the block address 305 to the storage medium 13 is received in the storage device 10A. Here, read data packets can be sequentially transmitted from the data buffer 123 via the host I/F 122 in block units, and the storage media block address 203 is not duplicated among the indices.

The data transfer control section 124 which has received the read command CP10 via the host I/F 122 starts the data transfer control in one block unit (step ST9a). Here, reference is made starting from an index value 0 (step ST9b).

The data transfer control section 124 judges whether the cache operation is valid or invalid by referring to the cache type field 204 in the table 121a which can be referred to by the index value M (step ST9c), and judges a read block data address is in the storage medium block address space 305 if the cache operation is valid (step ST9d).

If the cache operation is invalid in step ST9c or if the read block data address is out of the storage medium block address space 305 in step ST9d, the data transfer control section 124 checks whether the index reference value M is equal to the maximum index value n in the table 121a (step ST9e). If they are not equal, the data transfer control section 124 increments M to refer to a next index value (step ST9f), and again shifts to the processing in step ST9c.

On the other hand, if the read block data address is in the storage medium block address space 305 in step ST9d (Yes), the data transfer control section 124 judges whether the cache type field 204 in the table 121a which can be referred to by the index value M indicates buffer empty (step ST9g). If it indicates the buffer empty, the read block data is read from the storage medium 13 to the data buffer 123 (step ST9h). If it does not indicate the buffer empty, the read block data is read from the cache memory 14 to the data buffer 123 (step ST9i), and the data stored in the data buffer 123 is transferred to the host apparatus HA1 via the host I/F 122 (step ST9j), thus terminating the processing.

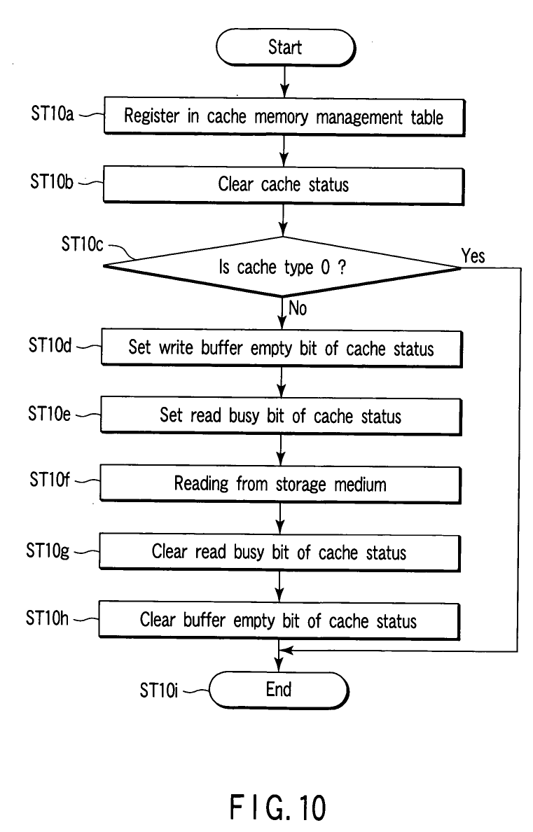

FIG. 10 is a flowchart showing the control processing procedure of the data transfer control section 124 when a host apparatus HA1 transmits, to the storage device 10A, a command packet including the command number and the argument CP11 to be registered in an arbitrary index in the table 121a.

The data transfer control section 124 which has received the command via the host I/F 122 registers contents of the command in the table 121a (step ST10a), and clears the cache status value (step ST10b). At this time, a check is made as to whether the cache type indicates 0, that is, no cache operation (step ST10c). If it indicates no cache operation, the processing is terminated (step ST10d). If it indicates other valid values, a buffer empty bit is set in the cache status value (step ST10d). When the storage medium 13 is accessible, a read busy bit is set in the cache status value (step ST10e), and valid data in the storage media block address space 203 specified in the table 121a is read from the storage medium 13 (step ST10f). When the storage medium 13 is accessible, the read busy bit in the cache status is cleared (step ST10g), and the buffer empty bit in the cache status is cleared and a buffer full bit is set therein (step ST10h), thus terminating the processing.

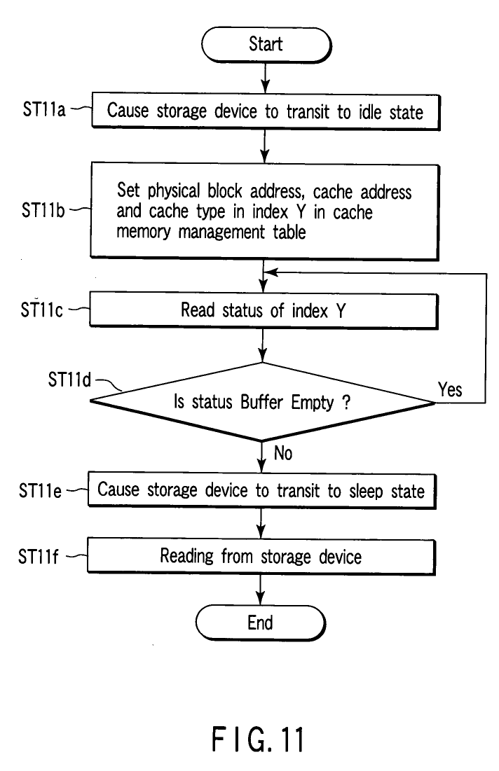

FIG. 11 is a flowchart showing a power management function of the storage device 10A, and the control processing procedure of the storage device 10A when a request to read status data of the storage medium 13 and the cache memory 14 has arrived from the host apparatus HA1.

The power management function of the storage device 10A has a sleep state and an idle or active state conforming to, for example, a conventional ATA-5 standard. A command to transit to the sleep and idle states can be issued from at least the host apparatus HA1. Data in the memory other than data in the storage medium 13 can be transferred even in the sleep state of the power management function.

If the host apparatus HA1 issues an arbitrary command packet, the storage device 10A transits to the idle state in which it can access the storage medium 13 (step ST11a). Then, by transmitting the command packet CP11 which includes the block address space 203 of the storage medium 13 to be read in an arbitrary cache index 201 in the table 121a, an arbitrary cache memory address space 302 including a cache memory space equal to the block address space, and an arbitrary cache type 304, the storage device 10A achieves registration in the table 121a (step ST11b).

If the host apparatus HA1 transmits the command packet CP12 to read the cache status of an arbitrary index Y201, the storage device 10A reads the cache status corresponding to the index in the table 121a in accordance with the command packet CP12 (step ST11c), and the processing in step ST11c is repeated while the cache status indicates the buffer empty (step ST11d).

Here, if it does not indicate the buffer empty any more, the block data to be read is stored in the cache memory 14, so that a host controller issues an arbitrary command packet. Then, the storage device 10A transits to the sleep state in which it can not access the storage medium 13 (step ST11e). Subsequently, when the command packet CP10 including the read command and the block address to the storage medium 13 set in step ST11b is received from the host apparatus HA1, data is read in accordance with this command packet CP10 (step ST11f).

As described above, in the first embodiment, when the command packet CP10 to write or read data in or from the storage medium 13 by use of the cache memory 14 is received from the host apparatus HA1, the data transfer control section 124 writes or reads data in or from the storage medium 13 and the cache memory 14 based on the command packet CP10 and the table 121a.

Therefore, the host apparatus HA1 can take partial charge of deciding the cache operation without relying on the data transfer control section 124 of the storage device 10A, thereby making it possible to efficiently use the cache memory 14 to write or read data in or from the storage medium 13 without causing a miss-hit. Moreover, since the table 121a is used, data can be written or read in or from the storage medium 13 and the cache memory 14 in a simple procedure.

Furthermore, in the first embodiment, since the cache status value in the table 121a is transmitted to the host apparatus HA1 in response to the request from the host apparatus HA1, the host apparatus HA1 can take partial charge of managing the states of the storage medium 13 and the cache memory 14 without relying on the storage device 10A, thereby making it possible to reduce power consumption associated with the management of the states of the storage medium 13 and the cache memory 14. Moreover, since efficient access to the storage medium 13 can be achieved, lives of data and the storage device 10A itself can be prolonged in some storage media 13.

Furthermore, in the first embodiment, since the capacity information indicating the capacity of the cache memory 14 and the information on the speed of accessing the cache memory 14 are transmitted to the host apparatus HA1 in response to the request from the host apparatus HA1, time to access the storage medium 13 and the cache memory 14 can be predicted on the basis of the capacity information and the access speed information on the host apparatus HA1 side.

### Second Embodiment

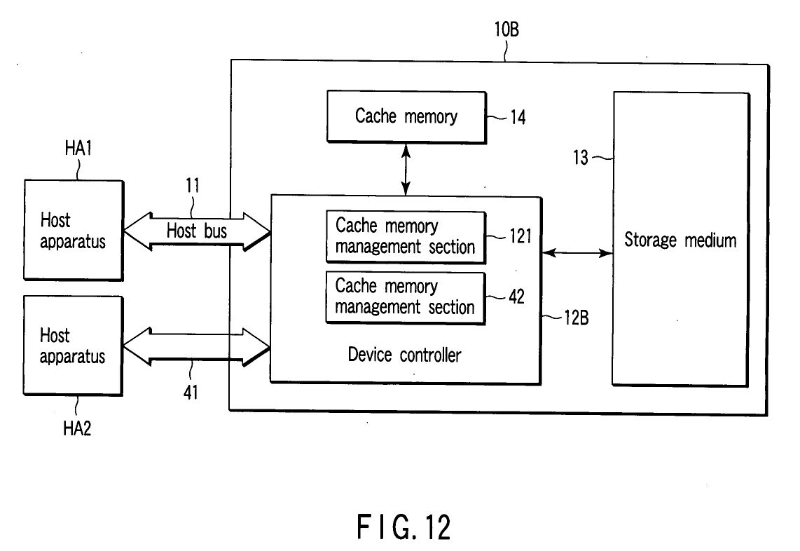

FIG. 12 is a block diagram showing a configuration of an information processing apparatus in a second embodiment according to this invention. It is to be noted that in FIG. 12, the same numerals are assigned to the same parts as those in FIG. 1 and these parts are not described in detail.

That is, a host apparatus HA2 is connected to a storage device 10B via a host bus 41 in addition to a host apparatus HA1. In this case, a device controller 12B writes or reads data in or from a storage medium 13 and a cache memory 14 on the basis of a cache memory management table provided in a cache memory management section 42 in response to a request from the host apparatus HA2.

It is to be noted that contents in the cache memory management table provided in the cache memory management section 42 do not overlap contents in the cache memory management table of the cache memory management section 121.

Thus, in the second embodiment, the cache memory management table is fixedly prepared for each of the host apparatuses HA1 and HA2. Therefore, even when requests to access the storage medium 13 and the cache memory 14 are made from the host apparatuses HA1 and HA2 at the same time, these accesses can be controlled in parallel, thereby making it possible to efficiently control a plurality of accesses to the storage medium 13 and the cache memory 14.

### Other Embodiments

It is to be noted that this invention is not limited to the embodiments described above. For example, an internal power source may be controlled in accordance with situations of accesses from a cache memory management table and a host apparatus. In this case, it is possible to reduce power consumption associated with operations to write and read data in and from a storage medium 13 and a cache memory 14.

Furthermore, examples in which the cache memory management table is used are described in the above embodiments, but it is possible to specify conditions on how the host apparatus uses the cache memory, and the cache memory may be controlled based on this specification.

In addition, various modifications can be made in the configuration of the storage device, the kind of storage medium, the contents of the cache memory management table, the procedure of writing and reading data and the like without departing from the spirit of this invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An information processing apparatus which performs at least one of an operation of directly writing and reading arbitrary information to and from a first recording medium, an operation of temporarily retaining information to be written to the first recording medium in a second recording medium and then writing the information to the first recording medium, and an operation of temporarily retaining information read from the first recording medium in the second recording medium and then reading the information from the second recording medium, in response to a request from an external device, the information processing apparatus comprising:
a obtaining circuit to obtain control information necessary for an operation requested through a communication with the external device upon the occurrence of one of requests to write the information to the first recording medium and read the information from the first recording medium by use of the second recording medium; and
a controller which performs one of writing of the information to the first and second recording media, and reading of the information from the first and second recording media, based on the control information.

2. The information processing apparatus according to claim 1, further comprising a memory to stores a management table showing a relation of a plurality of addresses classifying the first and the second recording media to states of the addresses,
wherein the controller updates information indicating the state of the relevant address in the management table based on contents of the control information, and performs one of the writing of the information to the first and second recording media and reading of the information from the first and second recording media, based on the updated information.

3. The information processing apparatus according to claim 2, wherein the controller updates the information indicating the state corresponding to the relevant address in the management table after having finished writing the information to one of the first and the second recording media.

4. The information processing apparatus according to claim 2, wherein the controller updates the information indicating the state corresponding to the relevant address in the management table after having finished reading the information from one of the first and the second recording media.

5. The information processing apparatus according to claim 2, further comprising transmitter which transmits information indicating a state of the management table to the external device in response to a request from the external device.

6. The information processing apparatus according to claim 5, wherein the transmitter transmits, to the external device, at least one of capacity information indicating capacity of the second recording medium and information on a speed of accessing the second recording medium in response to a request from the external device.

7. The information processing apparatus according to claim 1, wherein the controller controls a power source necessary for the operation of writing and reading the information in and from one of the first and the second recording media in accordance with a state of accessing one of the first and second recording media from the external device.

8. The information processing apparatus according to claim 2, when a plurality of external devices is connected,
wherein the memory stores a plurality of management tables corresponding to the external devices, and
the controller updates information indicating a recording state of the relevant address in the management table for each of the external devices based on the contents of the control information, and performs one of the writing and reading of the information in and from the first and second recording media based on the updated information.

9. A control method for an information processing apparatus which performs at least one of an operation of directly writing and reading arbitrary information in and from a first recording medium, an operation of temporarily retaining information to be written to the first recording medium in a second recording medium and then writing the information to the first recording medium, and an operation of temporarily retaining information read from the first recording medium in the second recording medium and then reading the information from the second recording medium, in response to a request from an external device, the method comprising:
obtaining control information necessary for an operation requested through a communication with the external device upon the occurrence of one of requests to write the information to the first recording medium and read the information from the first recording medium by use of the second recording medium; and
performing one of writing of the information to the first and the second recording media and reading of the information from the first and the second recording media, based on the control information.
